(19) United States
(12) Patent Application Publication
(10) Pub. No.: US 2024/0255166 A1
(43) Pub. Date: Aug. 1, 2024

(54) CONTROL METHOD AND CONTROL APPARATUS FOR SMART OCCUPANCY SENSOR SYSTEM

(71) Applicant: ELECTRONICS AND TELECOMMUNICATIONS RESEARCH INSTITUTE, Daejeon (KR)

(72) Inventors: Myung Soon KIM, Daejeon (KR); Wan Ki PARK, Daejeon (KR)

(21) Appl. No.: 18/505,395

(22) Filed: Nov. 9, 2023

(30) Foreign Application Priority Data
Jan. 30, 2023 (KR) 10-2023-0012140

(51) Int. Cl. F24F 11/49

(52) U.S. Cl. CPC F24F 11/49; F24F 2120/10

(57) ABSTRACT

A control method and control apparatus of a smart occupancy sensor system are provided. The control method includes receiving a switch status value of a switch configured to control power of a sensor module and a spatial information value of a space that is a detection target of the sensor module, generating a sensor priority signal based on the received switch status value and the received spatial information value, generating an increase event signal or a decrease event signal based on the sensor priority signal, and generating a new control signal and controlling the sensor module based on the generated new control signal.

### CROSS-REFERENCE TO RELATED APPLICATION

This application claims the benefit of Korean Patent Application No. 10-2023-0012140 filed on Jan. 30, 2023, in the Korean Intellectual Property Office, the entire disclosure of which is incorporated herein by reference for all purposes.

### BACKGROUND

### 1. Field of the Invention

One or more embodiments relate to technology for controlling a smart occupancy sensor system.

### 2. Description of Related Art

A smart occupancy sensor detects human movement at the entrance of a building or an indoor space through technology such as heat detection. When human movement is detected inside a building through a smart occupancy sensor, the space may be managed or controlled in conjunction with other smart devices using a remote management server or mobile app on a cell phone through wireless communication and a smart energy gateway. Recently, research has been actively being conducted to allow flexible use of these control apparatuses according to various occupancy/vacancy situations.

### SUMMARY

According to an aspect, there is provided a control method of a smart occupancy sensor system including receiving a switch status value of a switch configured to control power supply of a sensor module and a spatial information value of a space that is a detection target of the sensor module, generating a sensor priority signal based on the received switch status value and the received spatial information value, generating an increase event signal or a decrease event signal based on the sensor priority signal, and generating a new control signal and controlling the sensor module based on the generated new control signal.

The generating of the sensor priority signal may include generating the sensor priority signal based on a sensor of which the received switch status value and the received spatial information value changed according to a sensor priority hierarchy that indicates priority between sensors.

The generating of the increase event signal may include generating, when a value of a signal controlled by the switch needs to be increased, the increase event signal.

The control method may further include extracting a priority of a plurality of sensors included in a sensor priority hierarchy and generating a new control signal in order of decreasing priority.

The generating of the decrease event signal may include generating, when a value of a signal controlled by the switch needs to be decreased, the decrease event signal.

The control method may further include extracting a priority of a plurality of sensors included in a sensor priority hierarchy and generating a new control signal in order of increasing priority.

The new control signal may be a maximum value among new control signal values at the time the decrease event signal was generated.

The spatial information value may include information on a temperature of the space, humidity of the space, weather of the space, and a number of occupants of the space.

The control method may further include reporting an abnormal case when the increase event signal or the decrease event signal occurs.

According to an aspect, there is provided a control apparatus of a smart occupancy sensor system including a processor and at least one memory configured to store instructions executable by the processor. When the instructions are executed by the processor, the processor may receive a switch status value of a switch configured to control power supply of a sensor module and a spatial information value of a space that is a detection target of the sensor module, generate a sensor priority signal based on the received switch status value and the received spatial information value, generate an increase event signal or a decrease event signal based on the sensor priority signal, and generate a new control signal and control the sensor module based on the generated new control signal.

The processor may be configured to generate the sensor priority signal based on a sensor of which the received switch status value and the received spatial information value changed according to a sensor priority hierarchy.

The processor may be configured to generate, when a value of a signal controlled by the switch needs to be increased, the increase event signal.

The processor may be further configured to extract a priority of a plurality of sensors included in a sensor priority hierarchy and generate a new control signal in order of decreasing priority.

The processor may be configured to generate, when a value of a signal controlled by the switch needs to be decreased, the decrease event signal.

The processor may be configured to extract a priority of a plurality of sensors included in a sensor hierarchy and generate a new control signal in order of increasing priority.

The new control signal may be a maximum value among new control signal values at the time the decrease event signal was generated.

The spatial information value may include information on a temperature of the space, humidity of the space, weather of the space, and a number of occupants of the space.

The processor may be further configured to report an abnormal case when the increase event signal or the decrease event signal occurs in all sensors of a sensor priority hierarchy.

According to an aspect, there is provided a smart occupancy sensor system including a sensor module configured to receive a spatial information value of a space that is a detection target of the sensor module, a switch configured to control power supply of the sensor module, and a control apparatus configured to control the sensor module based on a control signal. The control apparatus may be configured to receive a switch status value of the switch configured to control the power supply of the sensor module and a spatial information value of the space that is a detection target of the sensor module, generate a sensor priority signal based on the received switch status value and the received spatial information value, and generate an increase event signal or a decrease event signal based on the sensor priority signal.

The sensor module may include at least one of a hardware switch, a temperature sensor, a humidity sensor, a software switch, or an occupant counting sensor.

Additional aspects of embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a diagram illustrating a concept of a smart occupancy sensor system according to an embodiment;

FIG. 2 is a diagram illustrating a sensor priority hierarchy according to an embodiment;

FIG. 3 is a diagram illustrating the concept of generating a signal based on a sensor priority hierarchy in a control method for a smart occupancy sensor system, according to an embodiment;

FIG. 4 is a flowchart illustrating an operation of generating a signal based on a sensor priority hierarchy in a control method for a smart occupancy sensor system, according to an embodiment;

FIGS. 5A to 5C are flowcharts illustrating an operation of generating an increase event signal or a decrease event signal in a control method for a smart occupancy sensor system, according to an embodiment; and

FIG. 6 is a block diagram illustrating a configuration of a control apparatus based on a sensor priority hierarchy, according to an embodiment.

### DETAILED DESCRIPTION

The following detailed structural or functional description is provided as an example only and various alterations and modifications may be made to embodiments. Thus, an actual form of implementation is not construed as limited to the embodiments described herein and should be understood to include all changes, equivalents, and replacements within the idea and the technical scope of the disclosure.

Although terms, such as first, second, and the like are used to describe various components, the components are not limited to the terms. These terms should be used only to distinguish one component from another component. For example, a first component may be referred to as a second component, and similarly the second component may also be referred to as the first component.

It should be noted that if one component is described as being “connected,” “coupled,” or “joined” to another component, the first component may be directly connected, coupled, or joined to the second component, or a third component may be “connected,” “coupled,” or “joined” between the first and second components.

The singular forms “a,” “an,” and “the” are intended to include the plural forms as well, unless the context clearly indicates otherwise. As used herein, each of phrases such as “A or B,” “at least one of A and B,” “at least one of A or B,” “A, B, or C,” “at least one of A, B, and C,” and “at least one of A, B, or C” may include any one of the items listed in the corresponding one of the phrases or all possible combinations thereof. It will be further understood that the terms “comprises/comprising” and/or “includes/including” used herein specify the presence of stated features, integers, steps, operations, elements, and/or components, but do not preclude the presence or addition of one or more other features, integers, steps, operations, elements, components and/or groups thereof.

Unless otherwise defined, all terms including technical and scientific terms used herein have the same meaning as commonly understood by one of ordinary skill in the art to which the present disclosure pertains. Terms such as those defined in commonly used dictionaries are to be interpreted as having a meaning that is consistent with their meaning in the context of the relevant art and are not to be interpreted in an idealized or overly formal sense unless expressly so defined herein.

As used in connection with the present disclosure, the term “module” may include a unit implemented in hardware, software, or firmware, and may interchangeably be used with other terms, for example, “logic,” “logic block,” “part,” or “circuitry”. A module may be a single integral component or a minimum unit or part thereof, adapted to perform one or more functions. For example, according to an embodiment, the module may be implemented in a form of an application-specific integrated circuit (ASIC).

In various energy management systems and methods that adopt a smart occupancy sensor and a real-time occupant counting sensor, a linear control method is used. The method stops or starts various energy consumption sources such as lighting and air conditioning/heating devices depending on the occupancy determination result, which makes it difficult to flexibly control apparatuses in the space according to various scenarios.

In this disclosure, a control method and control apparatus are disclosed. The control method may build and use a sensor priority hierarchy in which the priority of various sensors including scheduling, occupancy sensors, occupant counting sensors, weather information sensors, and temperature and humidity sensors are hierarchically classified and may control apparatuses using an energy management system (e.g., xEMS) control signal generation algorithm based on the hierarchy. Through the algorithm, logical contradictions that may arise when adopting a multiple control signal generation algorithm may be resolved, and user requirements may be satisfied in terms of both user convenience and energy saving.

Hereinafter, the embodiments are described in detail with reference to the accompanying drawings. When describing the embodiments with reference to the accompanying drawings, like reference numerals refer to like components and a repeated description related thereto is omitted.

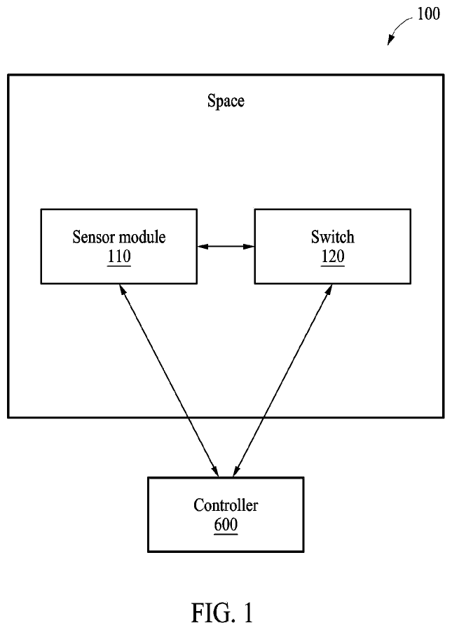

FIG. 1 is a diagram illustrating a concept of a smart occupancy sensor system according to an embodiment.

Referring to FIG. 1, a smart occupancy sensor system 100 according to an embodiment may include a sensor module 110 configured to receive a spatial information value of a space that is a detection target of the sensor module 110, a switch 120 configured to control power supply of the sensor module 110, and a control apparatus (e.g., a controller 600) configured to control the sensor module 110 based on a control signal. The controller 600 may receive a switch status value of the switch 120 that controls the power of the sensor module 110 and a spatial information value of the space that is a detection target of the sensor module 110, generate a sensor priority signal based on the received switch status value and the received spatial information value, and generate an increase event signal or a decrease event signal based on the sensor priority signal.

The sensor module 110 may include at least one of a hardware switch, a temperature sensor, a humidity sensor, a software switch, or an occupant counting sensor. The sensor module 110 may be installed in each space in a facility to detect an occupancy status of a user in the space and transmit the detected occupancy information to the controller 600.

The controller 600 may be connected to the sensor module 110 installed in the space through a wired or wireless network. In the case of a wireless network method, radio frequency (RF) communication or Wi-Fi communication may be used.

The controller 600 may provide occupancy information in real time through a display or a pre-registered user terminal. While an application (e.g., a mobile application) is running on a user terminal, the type of facility to be searched may be selected and the occupancy status of each space in the selected facility may be checked. Here, the application may correspond to an application provided by a management server. The user terminal may be a smartphone, smart pad, tablet personal computer (PC), laptop, and the like and may correspond to a terminal of an administrator or a terminal of a general user. The user terminal may be provided with related services from the controller 600 while the application is running. However, embodiments according to the present disclosure are not limited to the particular cases described above.

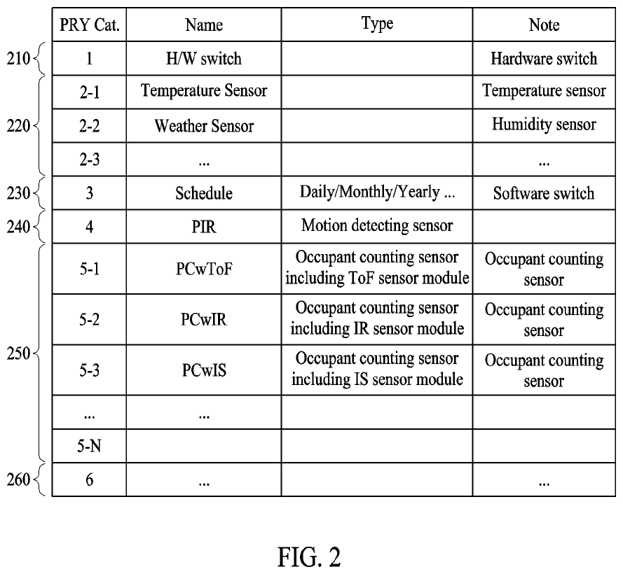

FIG. 2 is a diagram illustrating a sensor priority hierarchy according to an embodiment.

Referring to FIG. 2, a sensor priority hierarchy (PRY Cat) according to the priority of sensors in an energy management system is shown.

In an embodiment, a case 210 in which the value corresponding to the sensor priority hierarchy (PRY Cat) is “1” may include a case in which a control value is input in the form of a hardware switch. In this case, the case in which the control value is input in the form of a hardware switch, which corresponds to the case 210 in which the value corresponding to the sensor priority hierarchy is “1,” may be independent of a case in which the control value is input in the form of a software switch.

In an embodiment, a case 220 in which the value corresponding to the sensor priority hierarchy is “2” may include a case in which a sensor value related to temperature, humidity, or weather information is input.

In an embodiment, a case 230 in which the value corresponding to the sensor priority hierarchy is “3” may include a case in which a schedule control value related to information of the day, month, and year is input.

In an embodiment, a case 240 in which the value corresponding to the sensor priority hierarchy is “4” may include a case in which a value of a sensor that detects motion or movement of an object through ultraviolet rays is input.

In an embodiment, a case 250 in which the value corresponding to the sensor priority hierarchy is “5” may include a case in which a value of a sensor that detects occupant counting is input.

When the value corresponding to the sensor priority hierarchy is other than the values described above, such as in a case 260, categories related to various sensor values may be added without limits as necessary. On the contrary, the value corresponding to the sensor priority hierarchy may be changed without limits even when a category of the described value is not actually implemented. However, embodiments according to the present disclosure are not limited to the particular sensor priority hierarchy or examples shown in the drawings or described in the detailed description.

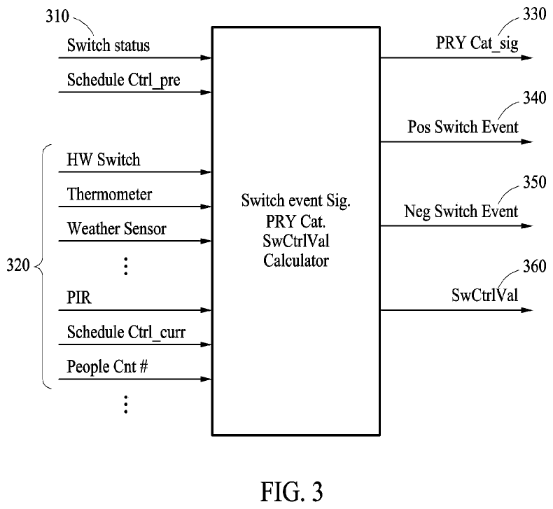

FIG. 3 is a diagram illustrating the concept of generating a signal based on a sensor priority hierarchy in a control method for a smart occupancy sensor system, according to an embodiment.

Referring to FIG. 3, a control apparatus may receive a switch status value 310 and a spatial information value 320.

The switch status value 310 received by the control apparatus may include information on the control of a hardware switch and a software switch. The spatial information value 320 received by the control apparatus may include information on the temperature of a space, the humidity of the space, the weather of the space, and the number of occupants of the space. The control apparatus may generate a sensor priority signal (PRY Cat_sig) 330, an increase event signal (Pos Switch Event) 340, a decrease event signal (Neg Switch Event) 350, and a new control signal (SwCtrlVal) 360 value based on the switch status value 310 and the spatial information value 320.

For example, the control apparatus may generate a sensor priority signal 330 according to the type of input sensor value that changed based on, for example, the sensor priority hierarchy shown in FIG. 2. The operation of generating the sensor priority signal 330 may include generating the sensor priority signal 330 based on a sensor of which the received switch status value 310 and the received spatial information value 320 changed according to the sensor priority hierarchy.

When receiving an input sensor value that requires the value of the signal controlled by the switch to increase, the control apparatus may generate the increase event signal 340. In this case, the signal value may vary depending on the type of control signal. The operation of generating the increase event signal 340 may include generating the increasing event signal 340 when the value of the signal controlled by the switch needs to be increased. The control apparatus may further perform an operation of extracting the priority of a plurality of sensors included in the sensor priority hierarchy and an operation of generating a new control signal in order of decreasing priority.

When receiving an input sensor value that requires the value of the signal controlled by the switch to decrease or an input sensor value that requires the switch to be turned off, the control apparatus may generate the decrease event signal 350. In this case, the signal value may vary depending on the type of control signal. The operation of generating the decrease event signal 350 may include generating the decrease event signal 350 when the value of the signal controlled by the switch needs to be decreased. The control apparatus may further perform an operation of extracting the priority of a plurality of sensors included in the sensor priority hierarchy and an operation of generating a new control signal in order of increasing priority. Here, the new control signal may be the maximum value among new control signal values at the time the decrease event signal 350 was generated.

The control apparatus may generate a new control signal 360 based on various input sensor values. In an embodiment, assuming there is a change in the Schedule Ctrl value, since Schedule corresponds to the case 230 in which the value corresponding to the sensor priority hierarchy is “3” in FIG. 2, the control apparatus may generate the sensor priority signal (PRY Cat_sig) as “3.” In an embodiment, the control apparatus may compare the previous Schedule Ctrl value to the currently input Schedule Ctrl and, when the value of the control signal has increased, may generate the increase event signal 340 and generate the new control signal 360 based on the increase event signal 340. In an embodiment, the control apparatus may compare the previous Schedule Ctrl value to the currently input Schedule Ctrl and, when the value of the control signal has decreased, may generate the decrease event signal 350 and generate the new control signal 360 based on the decrease event signal 350. The control apparatus may further perform an operation of reporting an abnormal case when an increasing event signal or a decreasing event signal occurs in all sensors of a sensor priority hierarchy.

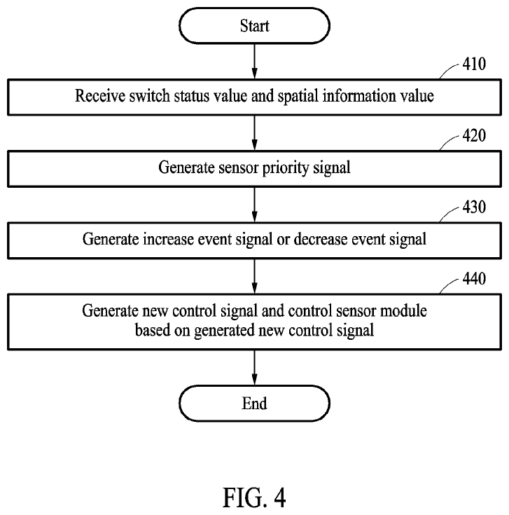

FIG. 4 is a flowchart illustrating an operation of generating a signal based on a sensor priority hierarchy in a control method for a smart occupancy sensor system, according to an embodiment.

Referring to FIG. 4, in operation 410, the control apparatus may receive the switch status value of the switch that controls the power supply of the sensor module and the spatial information value of a space that is a detection target of the sensor module. The switch that controls the power supply of the sensor module and the space that is a detection target of the sensor module may correspond to, for example, the description of the system described with reference to FIG. 1.

In operation 420, the control apparatus may generate a sensor priority signal based on the received switch status value and the received spatial information value. The operation of generating the sensor priority signal may include generating the sensor priority signal based on a sensor of which the received switch status value and the received spatial information value changed according to the sensor priority hierarchy.

In operation 430, the control apparatus may generate an increase event signal or a decrease event signal based on the sensor priority signal. The operation of generating the increasing event signal may include generating the increasing event signal when the value of the signal controlled by the switch needs to be increased. The operation of generating the decrease event signal may include generating the decrease event signal when the value of the signal controlled by the switch needs to be decreased.

In operation 440, the control apparatus may generate a new control signal and control the sensor module based on the generated new control signal. When an increase event signal is generated in operation 430, the control apparatus may further perform an operation of extracting the priority of a plurality of sensors included in the sensor priority hierarchy and an operation of generating a new control signal in order of decreasing priority. When a decrease event signal is generated in operation 430, the control apparatus may further perform an operation of extracting the priority of a plurality of sensors included in the sensor priority hierarchy and an operation of generating a new control signal in order of increasing priority.

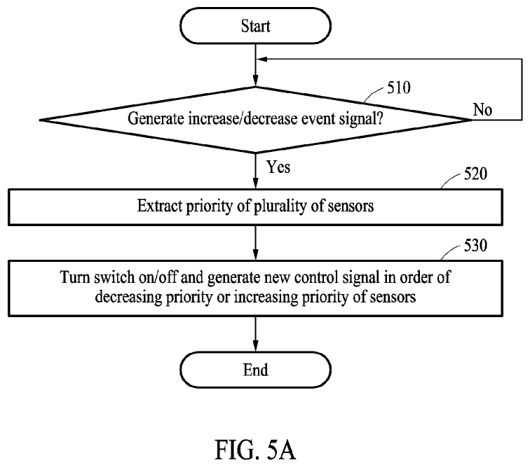

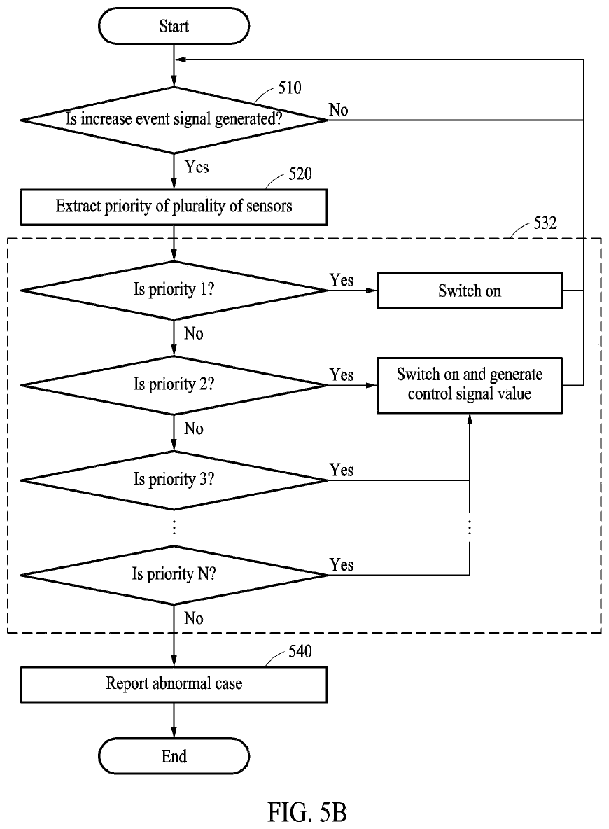

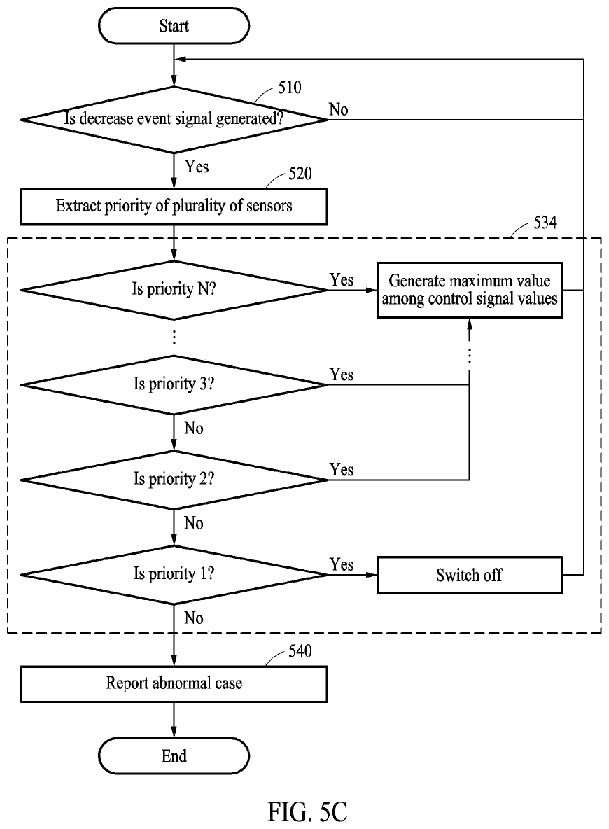

FIGS. 5A to 5C are flowcharts illustrating an operation of generating an increase event signal or a decrease event signal in a control method for a smart occupancy sensor system, according to an embodiment.

Referring to FIG. 5A, a control apparatus may generate the increase event signal or the decrease event signal in operation 510. For example, in a system as described with reference to FIG. 1, the control apparatus may generate an increase event signal when there is a change in the sensor module that requires the value of the signal controlled by the switch to increase and may generate a decrease event signal when there is a change in the sensor module that requires the value of the signal controlled by the switch to decrease.

In operation 520, the control apparatus may extract the priority of a plurality of sensors after detecting the generation of an increase event signal or a decrease event signal. The priority of the sensors may correspond to, for example, the sensor priority hierarchy as described with reference to FIG. 2.

In operation 530, the control apparatus may turn the switch on/off and generate a new control signal in order of decreasing priority or increasing priority of the sensors. For example, the control apparatus may perform an operation of turning the switch on/off and generating the new control signal according to a change in a sensor module value as described with reference to FIG. 1. Hereinafter, the operation of generating an increase event signal and the operation of generating a decrease event signal are described with reference to FIG. 5B and FIG. 5C, respectively.

Referring to FIG. 5B, an operation of the control apparatus may be checked when the switch is on or when the new control signal value changes to a positive value.

In operation 510, the control apparatus may determine whether an increase event signal is generated and, when the increase event signal occurs, may extract a priority category (PRY Cat.) in operation 520. In operation 532, the control apparatus may determine whether the increase event signal has occurred sequentially from high-priority sensors to low-priority sensors and may generate a new control signal according to the priority value to control the sensor. The control apparatus may perform a write operation in a portion such as a register of the system based on the corresponding priority value. When the increase event signal occurs in sensors corresponding to all priority categories (PRY Cat.) that may be classified in the corresponding algorithm or system, the control apparatus may report an abnormal case for the system operation status log in operation 540.

For example, when personnel start working in a space at 9 a.m. and end work at 6 p.m., the control apparatus may switch on the cooling/heating control at 9 a.m. and switch off the cooling/heating control at 6 p.m. through schedule control. The control apparatus may check an occupant counting sensor event after that time. When the number of occupants is a positive value, it may be a case in which the increase event signal has occurred due to the input sensor value of the event even when a schedule control value is in a lower priority category (PRY Cat.) compared to switch on. Thus, the control apparatus may generate a new control signal corresponding to the number of occupants and perform a control operation using the value of the generated new control signal. When a variety of occupant counting sensors are distributed, the control apparatus may generate a new control signal based on the maximum value among occupant counting values of each of the sensors.

Referring to FIG. 5C, an operation of the control apparatus may be checked when the switch is off or when the new control signal value changes to a negative value.

In operation 510, the control apparatus may determine whether a decrease event signal is generated and, when the decrease event signal occurs, may extract the priority category (PRY Cat.) in operation 520. In operation 534, the control apparatus may determine whether the decrease event signal has occurred sequentially from low-priority sensors to high-priority sensors and may generate a new control signal according to the priority value to control the sensor. The control apparatus may perform a write operation in a portion such as a register of the system based on the corresponding priority value. When a decrease event signal occurs in sensors corresponding to all priority categories (PRY Cat.) that may be classified in the corresponding algorithm or system, the control apparatus may report an abnormal case for the system operation status log in operation 540.

For example, when personnel start working in a space at 9 a.m. and end work at 6 p.m., the control apparatus may switch on the cooling/heating control at 9 a.m. and switch off the cooling/heating control at 6 p.m. through schedule control. In this case, the control apparatus may check the occupant counting sensor event from 9 a.m. When the number of occupants has a value of “0” for more than a determined period of time, it may be a case in which the decrease event signal has occurred due to the input sensor value in a lower priority category (PRY Cat.) even when the schedule control value has a positive new control signal value and the switch is on. Thus, the control apparatus may generate a new control signal corresponding to the number of occupants “0” and perform the control operation using the value of the generated new control signal. When a variety of occupant counting sensors are distributed, the control apparatus may generate a new control signal based on the maximum value among occupant counting values of each of the sensors.

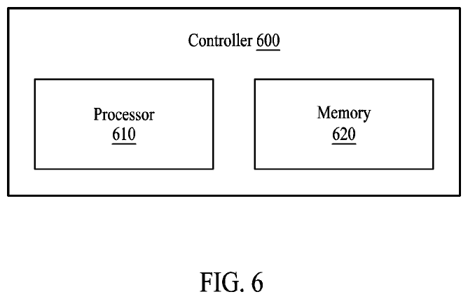

FIG. 6 is a block diagram illustrating a configuration of a control apparatus based on a sensor priority hierarchy, according to an embodiment.

Referring to FIG. 6, the controller 600 may include a processor 610 and a memory 620. Here, the controller 600 may correspond to the control method described with reference to FIGS. 1 to 5.

The memory 620 may be connected to the processor 610 and may store instructions executable by the processor 610, data to be computed by the processor 610, or data processed by the processor 610. The memory 620 may include a non-transitory computer-readable medium, for example, high-speed random-access memory (RAM), and/or a non-volatile computer-readable storage medium, for example, at least one disk storage device, a flash memory device, and other non-volatile solid-state memory devices.

The processor 610 may control the controller 600 to perform one or more operations related to the operation of the controller 600 described herein.

For example, the processor 610 may receive a switch status value of a switch configured to control power supply of a sensor module and a spatial information value of a space that is a detection target of the sensor module, generate a sensor priority signal based on the received switch status value and the received spatial information value, generate an increase event signal or a decrease event signal based on the sensor priority signal, and generate a new control signal and control the sensor module based on the generated new control signal.

For example, the processor 610 may generate the sensor priority signal based on a sensor of which the received switch status value and the received spatial information value changed according to a sensor priority hierarchy.

For example, the processor 610 may generate an increase event signal when a value of a signal controlled by the switch needs to be increased.

For example, the processor 610 may further perform operations of extracting a priority of a plurality of sensors included in a sensor hierarchy and generating a new control signal in order of decreasing priority.

For example, the processor 610 may generate the decrease event signal when the value of the signal controlled by the switch needs to be decreased.

For example, the processor 610 may further perform operations of extracting a priority of a plurality of sensors included in a sensor hierarchy and generating a new control signal in order of increasing priority.

For example, the processor 610 may be further configured to report an abnormal case when the increase event signal or the decrease event signal occurs in all sensors of a sensor priority hierarchy.

The components described in the embodiments may be implemented by hardware components including, for example, at least one digital signal processor (DSP), a processor, a controller, an ASIC, a programmable logic element, such as a field programmable gate array (FPGA), other electronic devices, or combinations thereof. At least some of the functions or the processes described in the embodiments may be implemented by software, and the software may be recorded on a recording medium. The components, the functions, and the processes described in the embodiments may be implemented by a combination of hardware and software.

The embodiments described herein may be implemented using a hardware component, a software component, and/or a combination thereof. For example, a processing device may be implemented using one or more general-purpose or special-purpose computers, such as, for example, a processor, a controller, an arithmetic logic unit (ALU), a DSP, a microcomputer, an FPGA, a programmable logic unit (PLU), a microprocessor, or any other device capable of responding to and executing instructions in a defined manner. The processing device may run an operating system (OS) and one or more software applications that run on the OS. The processing device may also access, store, manipulate, process, and create data in response to execution of the software. For purpose of simplicity, the processing device is described as singular. However, one of ordinary skill in the art will appreciate that a processing device may include multiple processing elements and/or multiple types of processing elements. For example, the processing device may include a plurality of processors, or a single processor and a single controller. In addition, a different processing configuration is possible, such as one including parallel processors.

The software may include a computer program, a piece of code, an instruction, or some combination thereof, to independently or collectively instruct or configure the processing device to operate as desired. Software and data may be embodied permanently or temporarily in any type of machine, component, physical or virtual equipment, or computer storage medium or device for the purpose of being interpreted by the processing device or providing instructions or data to the processing device. The software may also be distributed over network-coupled computer systems so that the software is stored and executed in a distributed fashion. The software and data may be stored in a non-transitory computer-readable recording medium.

The methods according to the embodiments may be recorded in non-transitory computer-readable media including program instructions to implement various operations of the embodiments. The media may also include the program instructions, data files, data structures, and the like alone or in combination. The program instructions recorded on the media may be those specially designed and constructed for the purposes of embodiments, or they may be of the kind well-known and available to those having skill in the computer software arts. Examples of non-transitory computer-readable media include magnetic media such as hard disks, floppy disks, and magnetic tape; optical media such as CD-ROM discs and DVDs; magneto-optical media such as optical discs; and hardware devices that are specially configured to store and perform program instructions, such as read-only memory (ROM), random-access memory (RAM), flash memory, and the like. Examples of program instructions include both machine code, such as those produced by a compiler, and files containing high-level code that may be executed by the computer using an interpreter.

The above-described hardware devices may be configured to act as one or more software modules in order to perform the operations of the above-described embodiments, or vice versa.

Although the embodiments have been described with reference to the limited number of drawings, one of ordinary skill in the art may apply various technical modifications and variations based thereon. For example, suitable results may be achieved if the described techniques are performed in a different order and/or if components in a described system, architecture, device, or circuit are combined in a different manner and/or replaced or supplemented by other components or their equivalents.

Therefore, other implementations, other embodiments, and equivalents to the claims are also within the scope of the following claims.

What is claimed is:

1. A control method of a smart occupancy sensor system, the control method comprising:
receiving a switch status value of a switch configured to control power supply of a sensor module and a spatial information value of a space that is a detection target of the sensor module;
generating a sensor priority signal based on the received switch status value and the received spatial information value;
generating an increase event signal or a decrease event signal based on the sensor priority signal; and
generating a new control signal and controlling the sensor module based on the generated new control signal.

2. The control method of claim 1, wherein the generating of the sensor priority signal comprises:
generating the sensor priority signal based on a sensor of which the received switch status value and the received spatial information value changed according to a sensor priority hierarchy that indicates priority between sensors.

3. The control method of claim 1, wherein the generating of the increase event signal comprises:
generating, when a value of a signal controlled by the switch needs to be increased, the increase event signal.

4. The control method of claim 3, further comprising:
extracting a priority of a plurality of sensors included in a sensor priority hierarchy; and
generating a new control signal in order of decreasing priority.

5. The control method of claim 1, wherein the generating of the decrease event signal comprises:
generating, when a value of a signal controlled by the switch needs to be decreased, the decrease event signal.

6. The control method of claim 5, further comprising:
extracting a priority of a plurality of sensors included in a sensor priority hierarchy; and
generating a new control signal in order of increasing priority.

7. The control method of claim 6, wherein the new control signal is a maximum value among new control signal values at the time the decrease event signal was generated.

8. The control method of claim 1, wherein the spatial information value comprises:
information on a temperature of the space, humidity of the space, weather of the space, and a number of occupants of the space.

9. The control method of claim 1, further comprising:
reporting an abnormal case when the increase event signal or the decrease event signal occurs.

10. A control apparatus of a smart occupancy sensor system, the control apparatus comprising:
a processor; and
at least one memory configured to store instructions executable by the processor,
wherein, when the instructions are executed by the processor, the processor is configured to:
receive a switch status value of a switch configured to control power supply of a sensor module and a spatial information value of a space that is a detection target of the sensor module;
generate a sensor priority signal based on the received switch status value and the received spatial information value;
generate an increase event signal or a decrease event signal based on the sensor priority signal; and
generate a new control signal and control the sensor module based on the generated new control signal.

11. The control apparatus of claim 10, wherein the processor is configured to:
generate the sensor priority signal based on a sensor of which the received switch status value and the received spatial information value changed according to a sensor priority hierarchy.

12. The control apparatus of claim 10, wherein the processor is configured to:
generate, when a value of a signal controlled by the switch needs to be increased, the increase event signal.

13. The control apparatus of claim 12, wherein the processor is further configured to:
extract a priority of a plurality of sensors included in a sensor priority hierarchy; and
generate a new control signal in order of decreasing priority.

14. The control apparatus of claim 10, wherein the processor is configured to:
generate, when a value of a signal controlled by the switch needs to be decreased, the decrease event signal.

15. The control apparatus of claim 14, wherein the processor is further configured to:
extract a priority of a plurality of sensors included in a sensor hierarchy; and
generate a new control signal in order of increasing priority.

16. The control apparatus of claim 15, wherein the new control signal is a maximum value among new control signal values at the time the decrease event signal was generated.

17. The control apparatus of claim 10, wherein the spatial information value comprises:
information on a temperature of the space, humidity of the space, weather of the space, and a number of occupants of the space.

18. The control apparatus of claim 10, wherein the processor is further configured to:
report an abnormal case when the increase event signal or the decrease event signal occurs in all sensors of a sensor priority hierarchy.

19. A smart occupancy sensor system comprising:
a sensor module configured to receive a spatial information value of a space that is a detection target of the sensor module;
a switch configured to control power supply of the sensor module; and
a control apparatus configured to control the sensor module based on a control signal,
wherein the control apparatus is configured to:
receive a switch status value of the switch configured to control the power supply of the sensor module and a spatial information value of the space that is a detection target of the sensor module;
generate a sensor priority signal based on the received switch status value and the received spatial information value; and
generate an increase event signal or a decrease event signal based on the sensor priority signal.

20. The smart occupancy sensor system of claim 19, wherein the sensor module comprises:
at least one of a hardware switch, a temperature sensor, a humidity sensor, a software switch, or an occupant counting sensor.
